(19) United States
(12) Patent Application Publication
(10) Pub. No.: US 2009/0273693 A1
(43) Pub. Date: Nov. 5, 2009

(54) SOLID-STATE IMAGING APPARATUS

(75) Inventor: Jun Aoki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/433,041

(22) Filed: Apr. 30, 2009

(30) Foreign Application Priority Data
May 2, 2008 (JP) 2008-120106

(51) Int. Cl. H04N 5/335

(52) U.S. Cl. 348/294

(57) ABSTRACT

Provided is a solid-state imaging apparatus which is capable of radiating heat generated in the solid-state imaging element by shifting a position of the solid-state imaging element. Also, a mechanism which suppresses an image blur caused by the shaking of a user's hand is provided therein. The solid-state imaging apparatus includes: an x-direction moving stage onto which a solid-state imaging element chip is fixed and is disposed via a x-direction movable member so as to move only in the x-direction; a y-direction moving stage disposed via a y-direction movable member so as to move only in the y-direction; and a plurality of metal spheres disposed in two-dimension is interposed between the x-direction moving stage and a heat conducting plate which is fixed onto a solid-state imaging apparatus case.

### CROSS-REFERENCE TO RELATED APPLICATIONS

This application claims priority from Japanese Patent Application No. 2008-120106, filed in the Japanese Patent Office on May 2, 2008, the disclosure of which is incorporated herein by reference.

### BACKGROUND OF THE INVENTION

1. Field of the Invention

The present invention relates to a solid-state imaging apparatus provided with a radiation mechanism for a solid-state imaging element disposed in the solid-state imaging apparatus.

2. Description of the Related Art

Conventionally, an image blur is caused by shaking of a user's hand when a digital camera is held by the hand during a photograph is taken. In order to suppress the image blur, a method of suppressing image blur is disclosed in such as a Patent Document 1 (Japanese Unexamined Patent Application, First Publication No. H06-46314). Such a method includes shifting a position of an imaging element disposed in a digital camera to a direction cancelling the shaking so as to correct the image blur.

Furthermore, a solid state imaging element provided with a semiconductor such as a CCD image sensor, a CMOS image sensor and the like, is employed in a solid state image apparatus such as the digital camera. However, an increase of temperature as well as increasing a dark current is occurred in the solid state imaging element provided with a semiconductor. Increase of the dark current causes an image of a captured object to be deteriorated. Furthermore, it becomes difficult to ensure a stable electronic operation of the solid state imaging element by the increase of temperature. In recent years, the amount of heat generated has increased, due to increasing the number of pixels and increased clock frequency of the solid state imaging element.

An example of a method for suppressing the heat generated by the solid state imaging element is disclosed in for example, a Patent Document 2 (Japanese Unexamined Patent Application, First Publication No. 2006-191465). The Patent Document 2 discloses a cooling method of the solid state imaging element by closely contacting a Peltier device to the solid state imaging element.

However, in the example of a shaking correction mechanism that cancels shaking of a user's hand by shifting the position of the solid state imaging element as described in the Patent Document 1, this may be disadvantageous with respect to heat radiation since the solid state imaging element is embedded into a movable member with a small dimension such as a stage. In order to overcome this disadvantage, the heat radiation mechanism of the Peltier device as described in the Patent Document 2, or a radiation fin may be provided. However, this will cause an increase of weight at the movable member; consequently, a greater load may be received in the operation of the movable member.

The present invention was conceived in view of the above-described circumstances, and has as its objective the provision of a solid state imaging apparatus which is capable of heat radiation of a solid state imaging element, even provided with the shaking correction mechanism which suppresses image blur by shifting the position of the solid state imaging element.

### SUMMARY OF THE INVENTION

In order to accomplish the above object, the present invention provides the following aspects:

An aspect of the present invention is a solid-state imaging apparatus, including:

a first member having a heat conductivity which is placed opposite to a back of a light receiving plane,

an imaging element which is movable along the plane of the first member,

a second member in which the imaging element is placed onto,

a plurality of substantially sphere-shaped third members which contact to the imaging element or the first and the second members, the third member controls a movement of the imaging element with respect to the first member and conducts a heat generated from the imaging element to the first member.

According to the solid-state imaging apparatus of the present invention, an increase of the temperature of the solid-state imaging element can be prevented by radiating heat generated in the solid-state imaging element without causing any loads onto the movement of the solid-state imaging element in order to cancel shaking of a user's hand. Thereby, a deterioration (image blur) of the image of the captured object can be prevented and a stable electronic operation of the solid-state imaging element can be ensured.

### BRIEF DESCRIPTION OF THE DRAWINGS

FIG. 1 is a perspective view of an outline of the solid-state imaging apparatus according to the first embodiment of the present invention.

FIG. 2 is a plain view showing a schematic structure of the solid-state imaging element chip and an antivibration mechanism of the first embodiment shown in FIG. 1.

FIG. 3 is a cross-sectional view as seen from a line A-A′ of FIG. 2.

FIG. 4 is a cross-sectional view as seen from a line A-A′ of a modified solid-state imaging apparatus according to the modified example of the first embodiment of the present invention shown in FIGS. 1-3 (corresponding to a position shown in FIG. 3).

### DETAILED DESCRIPTION OF THE INVENTION

Hereinbelow, the first embodiment of the present invention will be described with reference to the accompanying drawings.

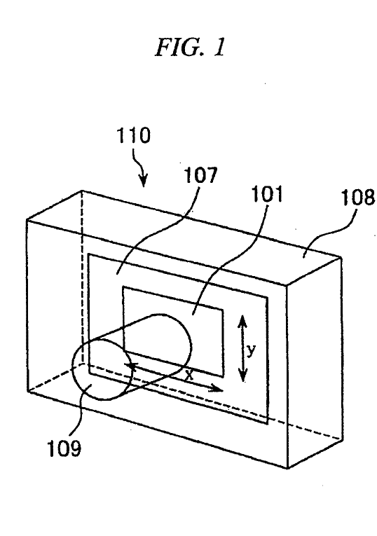

FIG. 1 is a perspective view of an outline of the solid-state imaging apparatus 110, shown in three dimensions. The solid-state imaging apparatus 110 captures an image of an object (not illustrated) through a shooting lens 109 by forming the image of the object on a solid-state imaging element chip 101.

The solid-state imaging element chip 101 (hereinafter abbreviated as an imaging element 101) is capable of moving within a plane by an antivibration mechanism 107 as indicated by arrows within a solid-state imaging apparatus case 108. At the time of photographing, when shaking of the solid-state imaging apparatus 110 occurs within a plane, the position of the imaging element 101 is shifted in the x-direction or the y-direction so as to cancel the shaking. Consequently, image blur is suppressed.

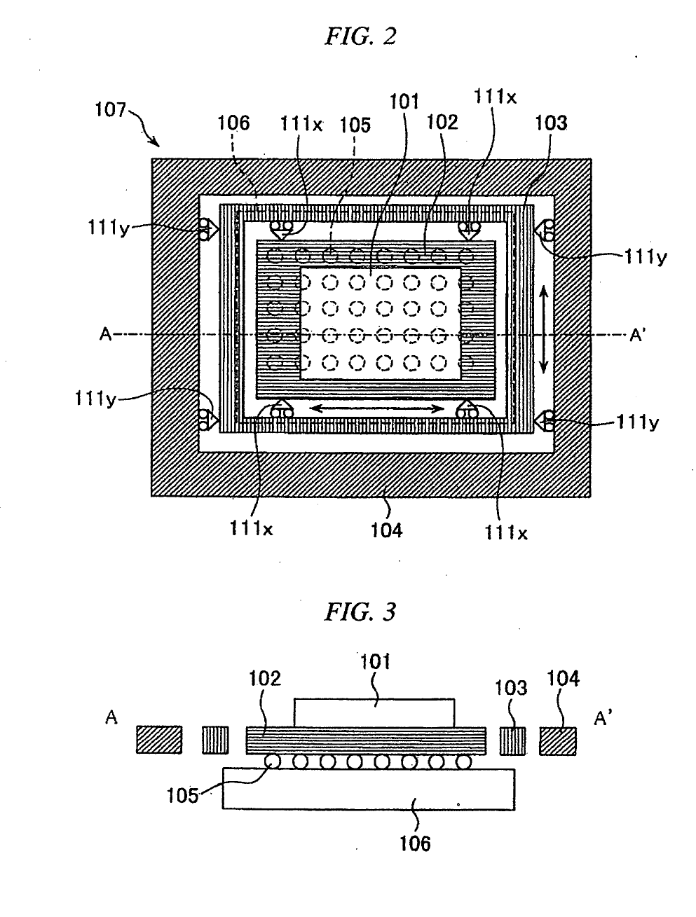

FIG. 2 is a plain view showing a schematic structure of the imaging element 101 and the antivibration mechanism 107 as seen from the shooting lens 109 side. FIG. 3 is a cross-sectional view as seen from a line A-A′ of FIG. 2. The antivibration mechanism 107 includes an x-direction moving stage 102 (a second member), a y-direction moving stage 103 (a second member), a moving stage supporting frame 104, an x-direction movable member 111x and a y-direction movable member 111y.

The imaging element 101 is fixed onto the x-direction moving stage 102 which is only movable in the x-direction with respect to the y-direction moving stage 103. Further, the x-direction movable member 111x is fixed onto the x-direction moving stage 102, which controls a movement of the x-direction moving stage 102 only in the x-direction with respect to the y-direction moving stage 103.

On the other hand, the y-direction moving stage 103 is capable of moving only in the y-direction with respect to the moving stage supporting frame 104. The y-direction movable member 111y is fixed onto the y-direction moving stage 103, which controls the movement of the y-direction moving stage 103 only to the y-direction with respect to the moving stage supporting frame 104. Further, the moving stage supporting frame 104 is fixed onto the solid-state imaging apparatus case 108. Thereby, the entire antivibration mechanism 107 is supported by the solid-state imaging apparatus case 108.

A plurality of metal spheres 105 disposed in two-dimension (a third member) is interposed between the x-direction moving stage 102 and a heat conducting plate 106 (a first member) which is fixed onto the solid-state imaging apparatus case 108. Thereby, heat generated from the imaging element 101 is radiated to the solid-state imaging apparatus case 108 via the x-direction moving stage 102, the metal spheres 105 and the heat conducting plate 106.

Next, an action of the solid-state imaging apparatus 110 constructed as described above when shaking occurs at the time of photographing while the solid-state imaging apparatus 110 is moved to a planar direction is explained. When shaking occurs, the x-direction moving stage 102 and the y-direction moving stage 103 are moved to a direction such that the shaking is cancelled by a signal sent from a control mechanism such as a controller. At the time, the metal spheres 105 also roll in the same direction of the movement of the x-direction moving stage 102.

Since the solid-state imaging apparatus 110 of the present embodiment is provided with the above-described structure, the metal spheres 105 roll while keeping the contact to the heat conducting plate 106 and the x-direction moving stage 102, even though the x-direction moving stage 102 and the y-direction moving stage 103 are moved to a direction in which shaking of a user's hand is cancelled. Thereby, there would not be any loads exerted upon the movement of cancelling the shaking. A heat generated at the imaging element 101 is radiated to the solid-state imaging apparatus case 108 via the metal spheres 105 and the heat conducting plate 106. Thereby, an increase of the temperature of the imaging element 101 can be prevented while suppressing image blur by caused by shaking of a user's hand. As a result, deterioration of the image of the captured object can be prevented and a stable electronic operation of the imaging element 101 can be ensured.

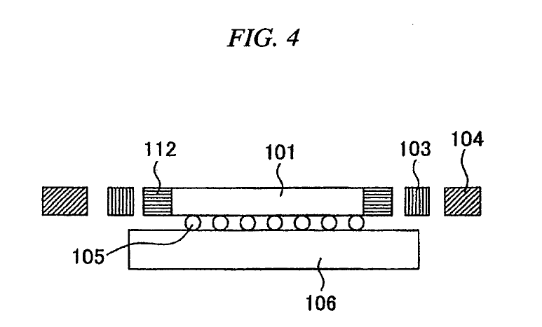

Next, a modified embodiment of the present invention will be explained in line with FIG. 4. In this modified embodiment, the imaging element 101 is fixed on a frame-structured x-direction moving stage 112, and a back plane of a light receiving plane of the imaging element 101 is directly made to contact with the metal spheres 105. By directly contacting the imaging element 101 with the metal spheres 105, a higher radiation effect can be expected. In addition, an insulating film may be disposed therebetween.

Furthermore, in the first and the modified embodiments, the heat conducting plate 106 may be connected to a cooling mechanism instead of connecting to the solid-state imaging apparatus case 108. Therefore, the present application may be applied as a method of cooling a solid-state imaging element. Furthermore, in the present embodiment, the plurality of metal spheres are placed in two-dimension, however the present invention is not limited thereto. A various design modifications can be included, provided that they do not depart from the gist of the present invention. Further, a mechanism for shifting a location of the solid-state imaging element is not limited thereto. Further, a metal sphere is used in the above embodiment as a substantially sphere shaped member which conducts a heat generated from the solid-state imaging element, however the material of the substantial sphere shaped member is not limited thereto; any materials may be employed as long as the material has a heat conductivity which ensures the radiation route.

While preferred embodiments of the invention will be described and illustrated below, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A solid-state imaging apparatus comprising:
a first member having a heat conductivity which is placed opposite to a back of a light receiving plane,
an imaging element which is movable along a plane of the first member,
a second member onto which the imaging element is placed,
a plurality of substantially sphere-shaped third members which make contact with the imaging element or the first and second members, the third members controlling a movement of the imaging element with respect to the first member and conducting a heat generated from the imaging element to the first member.
